(19) United States
(12) Patent Application Publication
(10) Pub. No.: US 2014/0082523 A1
(43) Pub. Date: Mar. 20, 2014

(54) COLLABORATIVE FORM FILLING AND DYNAMIC TRANSFER OF REDACTED INFORMATION

(71) Applicant: INTERNATIONAL BUSINESS MACHINES CORPORATION, Armonk, NY (US)

(72) Inventors: Joel Duquene, Raleigh, NC (US); Morris S. Johnson, JR., Cary, NC (US); Henri Meli, Cary, NC (US); Jacques-Marie Thrasybule, Raleigh, NC (US)

(73) Assignee: International Business Machines Corporation, Armonk, NY (US)

(21) Appl. No.: 13/622,528

(22) Filed: Sep. 19, 2012

(51) Int. Cl. G06F 3/01

(52) U.S. Cl. 715/753

(57) ABSTRACT

In a method for collaboratively sharing portions of a web document, a computer system receives a request from a requestor to redact web documents via a first collaboration tool of one or more collaboration tools. In one aspect, the computer system identifies designated portions of information in the web documents. The computer system redacts the designated portions of information. In addition, the computer system transmits the redacted web documents to a responder via a second collaboration tool. In another aspect, the computer system receives from the responder an altered version of the redacted web document via the second collaboration tool. In addition, the computer system redacts the altered version of the redacted web document. In another aspect, the computer system transmits the redacted altered version of the web document to the requestor via the first collaboration tool of the one of more collaboration tools.

### FIELD OF THE INVENTION

The present invention relates generally to collaborative form filling, and more particularly to collaborative transfer of designated portions of web documents between a plurality of actors.

### BACKGROUND

The Internet is a global network of computers and networks joined together by gateways that handle data transfer and the conversion of messages from a protocol of a sending network to a protocol used by a receiving network. For example, one or more computers can communicate with other computers over the Internet. Information between computers travels over the Internet through a variety of protocols. A set of protocols used on the Internet is called the Transmission Control Protocol/Internet Protocol (TCP/IP).

The Internet can be especially conducive to conducting electronic commerce and other business, or personal transactions conducted between one or more users. In addition, through the use of a user interface, such as a web browser, a user can have access to a plurality of web documents containing sensitive or confidential information. For example, the sensitive or confidential information in the web documents can be transmitted between one or more users over the Internet. Further, in business or personal settings, individuals frequently collaborate and share information over the Internet via collaboration tools, including, for example, instant message (IM) conversation, such as, IBM® Lotus® Sametime® (IBM, Lotus and Sametime are registered trademarks of International Business Machines Corporation in the United States, other countries of both). Moreover, collaborative tools allow users to communicate in real-time with other users through social networking websites, computing environments, cell phones, and/or other communication devices. For example, a user of a collaborative tool can be presented with information that can be transmitted over the Internet between other users of another collaborative tool. In addition, a user can be authenticated into an appropriate collaborative tool network over the Internet. Once the user is authenticated, and his/her presence on the system can be made known to all other authenticated users of the collaborative tool. The user can then exchange in free form, textual conversations with other collaborative tool users connected to the system.

### SUMMARY

In one embodiment, a method is provided for collaboratively sharing portions of a web document. The method comprises a computer system receiving a request from a requestor to redact web documents via a first collaboration tool of one or more collaboration tools. The method further comprises the computer system identifying designated portions of information in the web documents. The method further comprises the computer system redacting the designated portions of information of the web document. The method further comprises the computer system transmitting the redacted web documents to a responder via a second collaboration tool of the one or more collaboration tools. The method further comprises the computer system receiving from the responder an altered version of the redacted web document via the second collaboration tool of the one or more collaboration tools. The method further comprises the computer system redacting the altered version of the redacted web document. The method further comprises the computer system transmitting the redacted altered version of the web document to the requestor via the first collaboration tool of the one of more collaboration tools.

In another embodiment, a computer system is provided for collaboratively sharing portions of a web document. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises program instructions to receive a request from a requestor to redact web documents via a first collaboration tool of one or more collaboration tools. The computer system further comprises program instructions to identify designated portions of information of the web documents. The computer system further comprises program instructions to redact the designated portions of information of the web documents. The computer system further comprises program instructions to transmit the redacted web documents to a responder via a second collaboration tool of the one or more collaboration tools. The computer system further comprises program instructions to receive from the responder an altered version of the redacted web document via the second collaboration tool of the one or more collaboration tools. The computer system further comprises program instructions to redact the altered version of the redacted web document. The computer system further comprises program instructions to transmit the redacted altered version of the web document to the requestor via the first collaboration tool of the one of more collaboration tools.

In yet another embodiment, a computer program product is provided for collaboratively sharing portions of a web document. The computer program product comprises one or more computer-readable tangible storage devices and program instructions stored on at least one of the one or more storage devices. The computer program product further comprises program instructions to receive a request from a requestor to redact web documents via a first collaboration tool of one or more collaboration tools. The computer program product further comprises program instructions to identify designated portions of information of the web documents. The computer program product further comprises program instructions to redact the designated portions of information of the web documents. The computer program product further comprises program instructions to transmit the redacted web documents to a responder via a second collaboration tool of the one or more collaboration tools. The computer program product further comprise program instructions to receive from the responder an altered version of the redacted web document via the second collaboration tool of the one or more collaboration tools. The computer program product further comprises program instructions to redact the altered version of the redacted web document. The computer program product further comprises program instructions to transmit the redacted altered version of the web document to the requestor via the first collaboration tool of the one of more collaboration tools.

### BRIEF DESCRIPTION OF THE SEVERAL VIEWS OF THE DRAWINGS

Novel characteristics of the invention are set forth in the appended claims. The invention itself, however, as well as preferred mode of use, further objectives, and advantages thereof, will be best understood by reference to the following detailed description of the invention when read in conjunction with the accompanying Figures, wherein like reference numerals indicate like components, and:

FIG. 1 is a functional block diagram of a collaborative form filling system in accordance with embodiments of the present invention.

FIG. 2 is a functional block diagram illustrating program components of a requestor device in accordance with embodiments of the present invention.

FIG. 3 is an exemplary view of user interface elements added to a user interface of a requestor client program by a web page module in accordance with embodiments of the present invention.

FIG. 4 is a functional block diagram illustrating program components of responder host devices in accordance with embodiments of the present invention.

FIG. 5 is a functional block diagram of a server device in accordance with embodiments of the present invention.

FIG. 6 is a flowchart depicting steps performed by a server program of a server device in accordance with embodiments of the present invention.

FIG. 7 illustrates a block diagram of components of computer system in accordance with embodiments of the present invention.

### DETAILED DESCRIPTION

The present invention comprises functionality for collaborative transmission of web documents containing sensitive or confidential information via one or more collaboration tools between requestors and responders. In one embodiment, the present invention further comprises allowing a requesting party to designate or mark content in the web document as confidential, thus disabling a responding party from viewing the confidential information transmitted to the responding party via the one or more collaboration tools. Further, the requestor can optionally share all information contained in the web document with the responder. In another embodiment, once received, the responding party also has the ability to mark content in the transmitted web document as confidential. In a similar manner, the responding party can transmit an updated version of the confidential document back to requesting party via the one or more collaboration tools. In one aspect, either the requestor or responder can copy and paste partial components comprising the confidential information of the web documents into the one or more collaborative tools. In another aspect, either the requestor or responder can transmit the partially copied web documents to via the one or more collaborative tool.

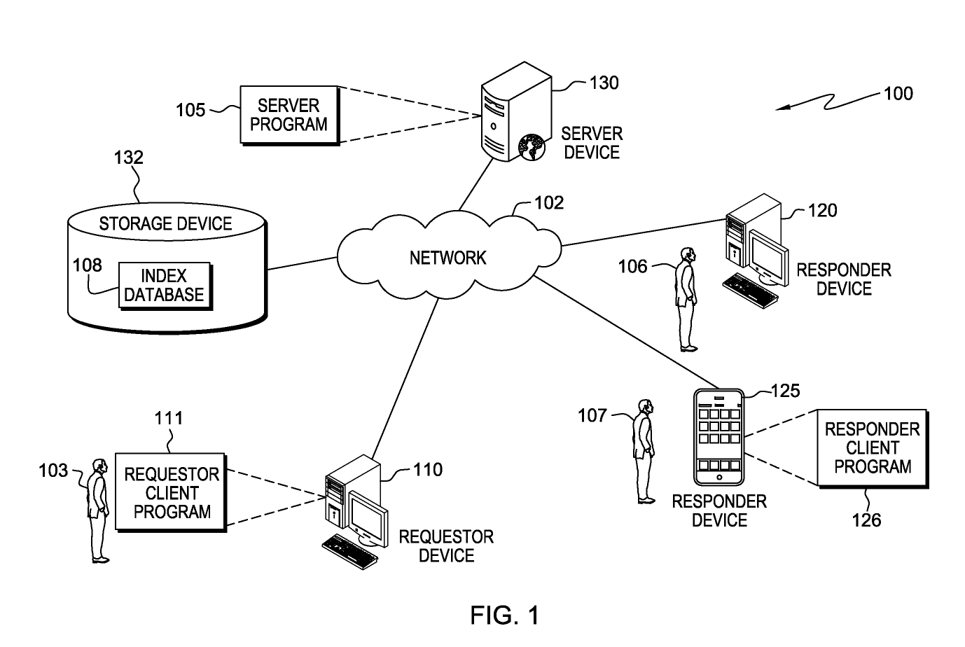

Further aspects of the present invention will now be described in conjunction with the Figures. Referring to FIG. 1, collaborative form filling system 100 for transferring portions of information in web documents in real time is shown.

Collaborative form filling system 100 comprises network 102, requestor device 110, responder devices 120, 125, server device 130 and storage device 132. Requestor device 110 and responder devices 120, 125 are clients to server device 130, interconnected over network 102. Requestor device 110 and responder devices 120, 125 operate over network 102 with server device 130 to facilitate transfer of confidential information in web documents between requestor 103 and responders 106, 107 in collaborative form filling system 100. In one aspect, requestor 103 can be a host that initiates a request to share the confidential information with participants including, for example, responders 106, 107. In one example, roles of sharing information in the collaborative system application between requestor 103 and responders 106, 107, can be interchangeable, as described in more details below, in accordance with embodiments of the present invention.

Requestor device 110 can be, for example, a laptop, tablet, or notebook personal computer (PC), a desktop computer, a mainframe or mini computer, a personal digital assistant (PDA), or a smart phone such as a Blackberry® (Blackberry is a registered trademark of Research in Motion Limited (RIM) Inc., in the United States, other countries, or both) or iPhone® (iPhone is a registered trademark of Apple Inc., in the United States, other countries, or both), respectively. Requestor device 110 comprises requestor client program 111. Requestor client program 111 can be any type of software application that is compatible to retrieve and display portions of confidential information collaboratively shared between requestor 103 and responders 106, 107 in a collaborative system application, in accordance with embodiments of the present invention. In addition, responder devices 120, 125 can be, for example, a laptop, tablet, or notebook personal computer (PC), a desktop computer, a mainframe or mini computer, a personal digital assistant (PDA), or a smart phone such as a Blackberry® (Blackberry is a registered trademark of Research in Motion Limited (RIM) Inc., in the United States, other countries, or both) or iPhone® (iPhone is a registered trademark of Apple Inc., in the United States, other countries, or both), respectively. Each one of responder devices 120, 125 comprises an instance of responder client program 126.

Server device 130 can be, for example, a server computer system such as a management server, a web server, or any other electronic device or computing system capable of receiving and sending data, in accordance with an embodiment of the present invention. Further, server device 130 can also represent a “cloud” of computers interconnected by one or more networks, where server device 130 can be a primary server for a computing system utilizing clustered computers when accessed through network 102. For example, a cloud computing system can be an implementation of a collaborative form filling system for transferring confidential information in web documents between requestor 103 and responders 106, 107 in real time, in accordance with an embodiment of the present invention. Server device 130 includes server program 105. Server program 105 performs all necessary functions to redact information in documents based on information designated as confidential by either requestor 103 or responders 106, 107, in a collaborative system application. In particular, the collaborative system application can be executed to operate in either requestor device 110 or responder devices 120, 125.

Storage device 132 can be any type of storage device, storage server, storage area network, redundant array of independent discs (RAID), cloud storage service, or any type of data storage. Index database 108 can be a database of indexed web pages stored in storage device 132 for retrieval by requestor client program 111 or responder client program 126, over network 102. In one aspect, once retrieved, the web pages can be displayed in a user interface of requestor device 110 and responder device 120, 125 for viewing by requestor 103 or responders 106, 107, in accordance with one embodiments of the present invention.

Network 102 includes one or more networks of any kind that can provide communication links between various devices and computers connected together within collaborative form filling system 100. Network 102 can also include connections, such as wired communication links, wireless communication links, or fiber optic cables. In addition, network 102 can be implemented as a number of different types of networks, including, for example, a local area network (LAN), wide area network (WAN) or a packet switched telephone network (PSTN), or some other networked system. In one embodiment, network 102 collaborative form filling system 100 is the Internet representing a worldwide collection of networks. The term “Internet” as used according to embodiments of the present invention refers to a network or networks that uses certain protocols, such as the TCP/IP protocol, and possibly other protocols, such as the hypertext transfer protocol (HTTP) for hypertext markup language (HTML) documents that make up the world wide Web (the web). Further, content from the Internet is often provided by content servers, including, for example, server device 130 and is transmitted to client display devices, including, for example, requestor device 110 and responder devices 120, 125. At the heart of the Internet is a backbone of high-speed data communication lines between major nodes or host computers, consisting of thousands of commercial, government, educational and other documents that can be transferred in a collaborative application between requestor 103 and responder 106, 107, according to an embodiment of the present invention.

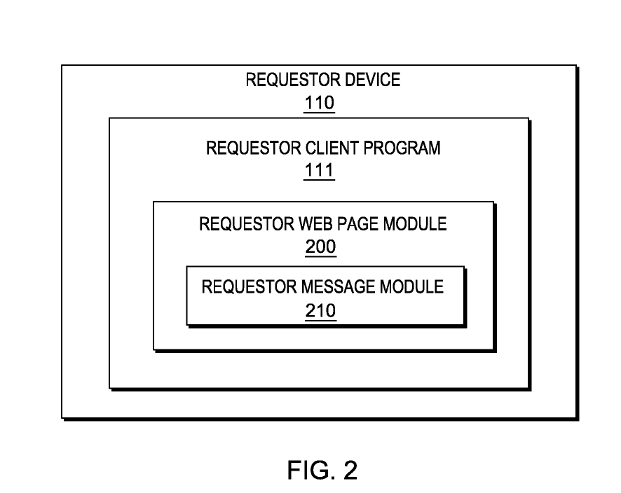

FIG. 2 is a functional block diagram illustrating program components of requestor device 110 in accordance with an embodiment of the present invention.

In the depicted embodiment, requestor device 110 comprises requestor client program 111. Requestor client program 111 can among other things, retrieve and display content accessible via network 102, such as web pages. In one embodiment, requestor client program 111 is a web browser. Examples of web browsers include Internet Explorer® (Internet Explorer is a trademark of Microsoft Inc., in the United States, other countries or both), Firefox® (Firefox is a trademark of Mozilla Corporation, in the United States other countries, or both), Safari® (Safari is a trademark of Apple, Inc. in the United States, other countries, or both) and Google Chrome™ (Google Chrome is a trademark of Google, Inc. in the United States, other countries, or both), respectively.

Requestor client program 111 comprises requestor web page module 200. In at least one embodiment, requestor web page module 200 is a web browser plugin/add-on that extends the functionality of requestor client program 111 by adding additional user interface elements to a user interface of requestor client program 111. The additional user interface elements allow requestor 103 to select portions of information of web documents, and optionally share the selected portions of information with responders 106, 107. In at least one embodiment, requestor web page module 200 comprises a web page received in requestor client program 111 from a web server program. The web page received in requestor client program 111, including for example, requestor web page module 200 can include program code, such as HyperText Markup Language (HTML) code or JavaScript code that when executed, adds one or more user interface elements to requestor client program 111.

In at least one embodiment, requestor web page module 200 comprises requestor message module 210. Requester message module 210 is a web browser plugin/add-on that extends the functionality of requestor web page module 200 by adding additional user interface elements to a user interface of requestor web page module 200. In particular, requestor message module 210 allows requestor 103 to collaboratively share portions of information of web documents with responders 106, 107. In one embodiment, requestor message module 210 is an instant messenger program that allows instantaneous transmission of information between requestor 103 and responder 106, 107, in accordance with embodiments of the present invention. In one example, an instant messaging program can be IBM® Lotus® Sametime® (IBM, Lotus and Sametime are registered trademarks of International Business Machines Corporation in the United States, other countries of both).

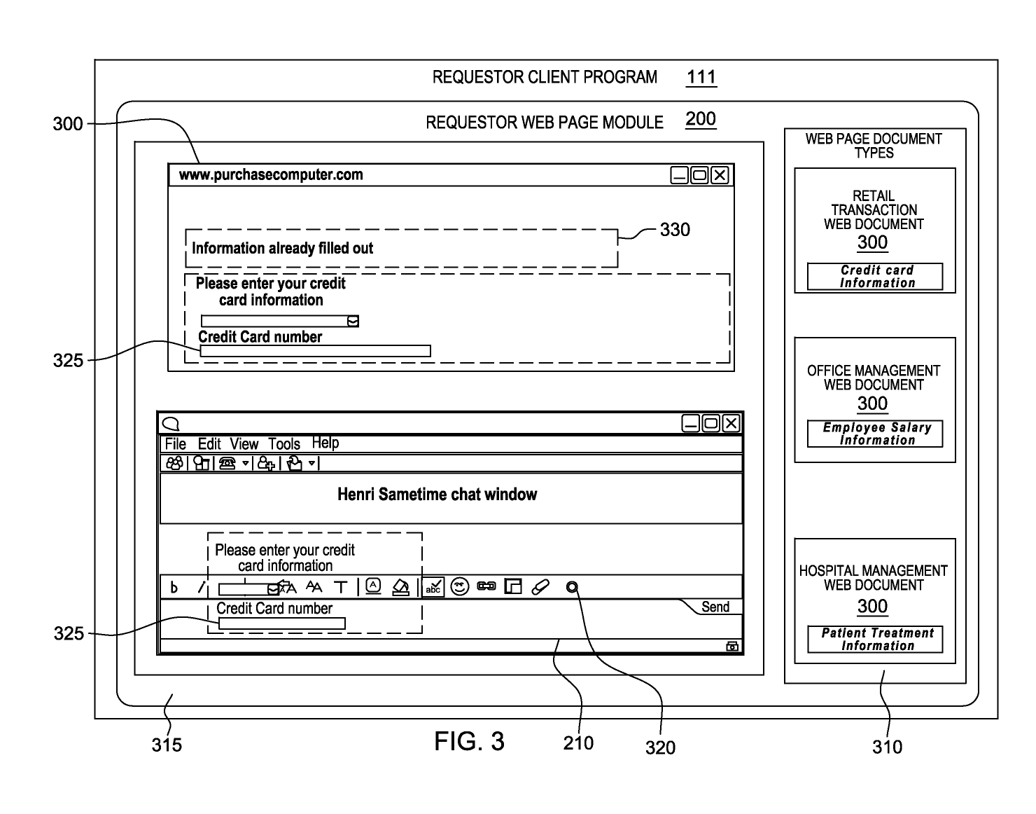

FIG. 3 is an exemplary view of user interface elements added to a user interface of requestor client program 111 by requestor web page module 200 in accordance with embodiments of the present invention. Requestor web page module 200 populates the user interface of requestor client program 111 with one or more web document types 300 and requestor messaging module 210. Web document types 300 can comprise a collection of linked individual pages, each with optional scrolling and non-scrolling areas, text, images, and other media embedded or electronic web document pages, in accordance with embodiments of the present invention.

In particular, web documents types 300 can comprise confidential information relating to online retails transactions, including, for example, credit card information. Web document types 300 can further comprise office management information, including, for example, employee salary information. Further, web document types 300 can also comprise, hospital management information, including, for example, patient treatment information in a medical workflow environment. In one aspect, information, including confidential information in an online transaction, work environment or hospital management, etc., can be collaboratively shared between requestor 103 and responder 106, 107, in accordance with embodiments of the present invention. In at least one embodiment, web document types 300 can be displayed in document type selection area 310 of the user interface of requestor client program 111, in accordance with embodiments of the present invention.

In one aspect, requestor web page module 200 can allow requestor 103 to arrange web document types 300 on canvas 315 in a layout according a preference of web document types 300 that requestor 103 desires to share with responder 106, 107. In at least one embodiment, requestor web page module 200 can contain preexisting web page document types on canvas 315. In another embodiment, requestor 103 can drag and drop one or more web document types 300 from selection area 310 onto canvas 315. In yet another embodiment, requestor 103 can copy one or more web document types 300 from selection area 310 and paste the copied one or more web document types 300 onto canvas 315. In yet another embodiment, requestor 103 can resize one or more web document types 300 dropped or copied onto canvas 315.

In the depicted embodiment, requestor 103 fills out information on web document types 300 on canvas 315 of requestor web page module 200 during a retail or management transaction. However, in order to complete the transaction, requestor 103 needs to input additional information on web document types 300. The additional information that requestor 103 needs to complete on web document types 300 can include, for example, credit information, employee salary information or other private or confidential information related to patients in a hospital environment that can be redacted and collaboratively shared between requestor 103 and responders 106, 107, during a chat session on requestor message module 210 and a responder message program of responder client program 126.

In one example, requestor 103 is in a process of completing the online purchase transaction by completing required credit card information on web document types 300 on canvas 315 of requestor web page module 200. Nevertheless, requestor 103 does not have a valid credit card number to complete the online purchase required by web page document type 300. However, requestor 103 can use responders 106, 107 credit card information to complete the online purchase. In one aspect, both requestor 103 and responder 106, 107 can collaboratively share content of web document types 300, including, the needed credit card information through requestor message module 210 and a responder message program of responder client program 126.

In one aspect, requestor 103 contacts responder 106, 107 through requestor message module 210 and inquires if responder 106, 107 can complete portions of the requested credit card information on web document types 300 with responder 106, 107 credit card information. However, responder 106, 107 doesn't want to publicly share his or her credit card information with requestor 103. Instead responder 106, 107 would like requestor 103 to send him or her a portion of web document types 300 via requestor message module 210. In one embodiment, the portion of web document types 300 includes content specifying the credit card information that needs to be completed by requestor 103 during requestor's online purchase transaction, as previously described.

In particular, requestor 103 selects context button 320 on requestor message module 210 during the chat session with responder 106, 107. Context button 320 allows both requestor 103 and responder 106, 107 to select portions on web document and collaboratively share the selected portion of web document types 300 with either party. In the depicted embodiment, text box 325 contains space for credit card information that needs to be filled out by responder 106, 107 before requestor 103's online purchase transaction can be completed. Information box 330 contains information that has already been filled out by requestor 103, and does not need to be completed by responder 106, 107. Information in information box 330 can include, for example, address, or other information that has been filled out by requestor 103. In addition, requestor 103 copies text box 325 onto his chat window, for example, as depicted, requestor copies text box 325 into “Henri (requestor 103) Sametime Chat window”, and submits text box 325 to responder device 120, 125 via requestor message module 210 and the submitted text box 325 will be received by a responder message program of a responder web page module of responder client program 126.

In one aspect, both requestor web page module 200 and a responder's web page module of responder client program 126 can be similar web browsers, for instance, any information transmitted between requestor message module 210 and a responder message program is transparent. For example, copied text box 325 from requestor web page program is transparent in responder web page program. In particular, if a specific style sheet needs to be copied, the style sheet can be identified by either requestor web page program or responder web page program.

Further, once the submitted text box 325 is received, responder 106, 107 views and fills out relevant information that needs to be completed for responder 103. In one example, responder 106, 107 selects the appropriate credit card information that needs to be completed in text box 325. In one embodiment, the credit card information completed in text box can be encrypted or redacted, therefore, not visible once text is submitted to requestor message module 210. In a similar manner, once responder 106, 107 completes filling out the credit card information in text box 325, responder 106, 107 can transmits the information in text box 325 back to requestor 103 via a responder message program of responder client program 126. Once received in requestor message module 210, requestor 103 loads the information on web document type 300 on canvas 315 of requestor web page module 200.

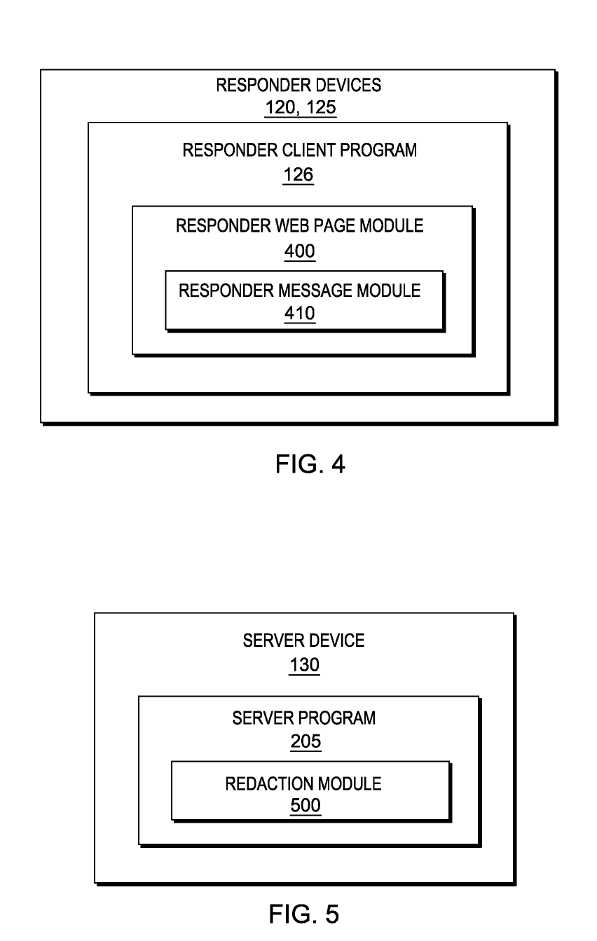

FIG. 4 is a functional block diagram illustrating program components of responder devices 120, 125 in accordance with an embodiment of the present invention.

In the depicted embodiment, responder devices 120, 125 comprises responder client program 126. Responder client program 126 can, among other things, retrieve and display content accessible via network 102, such as web pages. In one embodiment, responder client program 126 is a web browser. Examples of web browsers include Internet Explorer® (Internet Explorer is a trademark of Microsoft Inc., in the United States, other countries or both), Firefox® (Firefox is a trademark of Mozilla Corporation, in the United States other countries, or both), Safari® (Safari is a trademark of Apple, Inc. in the United States, other countries, or both) and Google Chrome™ (Google Chrome is a trademark of Google, Inc. in the United States, other countries, or both), respectively.

Responder client program 126 comprises responder web page module 400. In at least one embodiment, responder web page module 400 is a web browser plugin/add-on that extends the functionality of responder client program 126 by adding additional user interface elements to a user interface of responder client program 126. The additional user interface elements allow responder 106, 107 to enter select portions of information in web documents, and optionally share the selected portions of information with requestor 103. In at least one embodiment, responder web page module 400 comprises a web page received in responder client program 126 from a web server program. The web page received in responder client program 126, including for example, responder web page module 400 can include program code, such as HyperText Markup Language (HTML) code or JavaScript code that, when executed, adds one or more user interface elements to a responder client program 126.

In at least one embodiment, responder web page module 400 comprises responder message module 410. Responder message module 410 is a web browser plugin/add-on that extends the functionality of responder web page module 400 by adding additional user interface elements to a user interface of responder web page module 400. In particular, responder message module 410 allows responder 106, 107 to collaboratively share portions of information of web documents with another one of responders 106, 107. In one embodiment, responder message module 410 is an instant messenger program that allows instantaneous transmission of information between responder 106, 107 and requestor 103, in accordance with embodiments of the present invention. In one example, an instant messaging program can be IBM® Lotus® Sametime® (IBM, Lotus and Sametime are registered trademarks of International Business Machines Corporation in the United States, other countries of both).

FIG. 5 is a functional block diagram illustrating program components of server device 130 in accordance with an embodiment of the present invention.

Server device 130 comprises server program 105. In one aspect, server program 105 performs functions to dynamically identify and redact information selected as confidential in web documents by either requestor 103 or responder 106, 107. In another aspect, the information is transmitted to server program 105 by either requestor message module 210 or responder message module 410. In yet another aspect, server program 105 identifies information in text box 325 designated as confidential by, for example, requestor 103 that is transmitted to server program 105 via requestor message module 210.

Server program 105 comprises redaction module 500. Redaction module 500 is configured to redact portions of information designated as confidential, in accordance with embodiments of the present invention. Redaction module 500 redacts certain portions of information contained in web documents while not redacting other portions of web documents based on preference by either requestor 103 or responder 106, 107, to redact the selected portion of web documents types 300. Further, once the information is redacted, server program 105 can further be adapted to replace the portions of web page documents types 300 that are redacted by redaction module 500, with an updated version of the redacted document. In addition, server program can dynamically populate a user interface containing web page document types 300 with the redacted portions of information transmitted to either requestor message module 210 or responder message module 410, to be displayed on the user interface of either requestor web page module 200 or responder web page module 400.

In particular, redactor receives information containing multiple elements designated as confidential by requestor 103 or responders 106, 107 from either requestor message module 210 or responder message module 410. Redaction module 500 redacts the confidential information, and transmits the redacted information back to either requestor message module 210 or responder message module 410 to be viewed by requestor 103 or responders 106, 107. In one embodiment, a matching algorithm can be utilized by redaction module 500 to redact specific portions in web document marked as confidential, in accordance with embodiments of the present invention. In one example, redaction module 500 can redact selected portions of web document, such as, for example, “14825-236-001” as appearing in a web document, with a fixed string “XXXXX-XXX-XXX”. Specifically, redaction module 500 can replace information identified by server program 105 as confidential by a fixed length string, and ensure that no information pertaining to the fixed-length string is leaked in the redacted information transmitted to requestor message module 210 or responder message module 410 by server program 105. In another embodiment, any redaction program can be utilized by redaction module 500 of server program 105 to redact portions of confidential information in web documents types 300, in accordance with embodiments of the present invention.

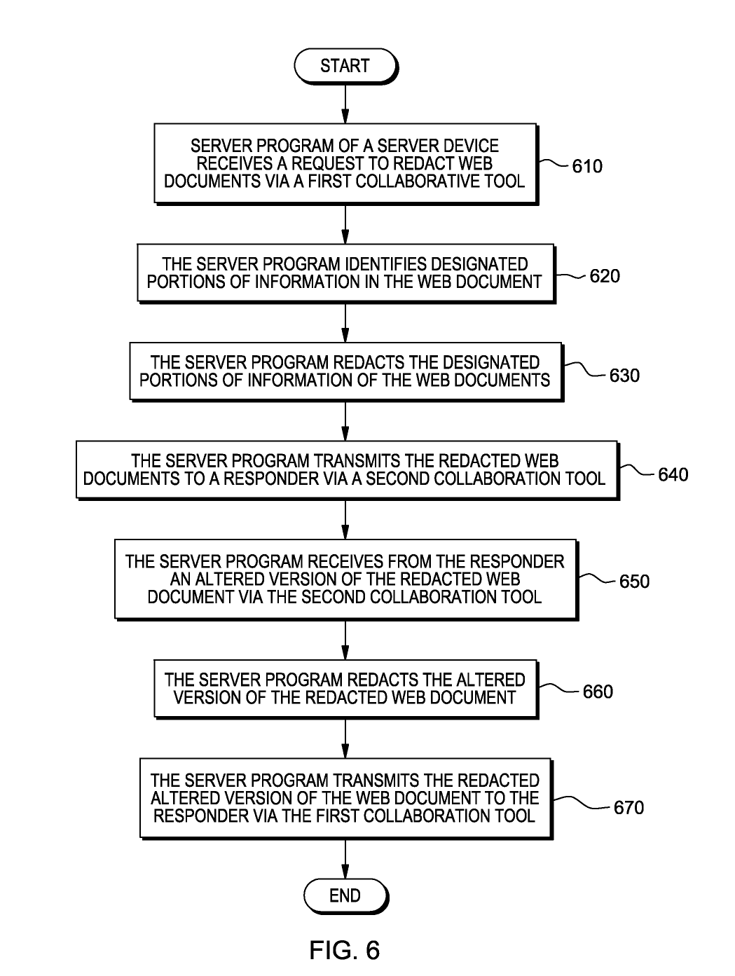

FIG. 6 is a flowchart depicting steps performed by server program 105 of server device 130, in accordance with embodiments of the present invention.

In step 610, server program 105 of server device 130 receives a request from requestor 103 to redact web documents types 300 via requestor message module 210. In step 620, server program 105 identifies designated portions in web documents. In one aspect, the designated portions in the web documents are includes in text box 325 of web document types 300, and transmitted to server program 105. In step 630, server program 105 redacts the designated portions of information of the web documents types 300. In step 640, server program transmits the redacted web document types 300 to responder message module 410. In step 650, server program 105 receives from responder 106, 107, an altered or updated version of the redacted designated portions of information of web document types 300. In step 660, server program redacts the altered version of the designated portions of information of the web document types 300. In step 670, server program 105 transmits the redacted altered version of designated portions of the web documents to requestor message module 210 of requestor web page module 200 to be displayed on requestor devices 120, 125.

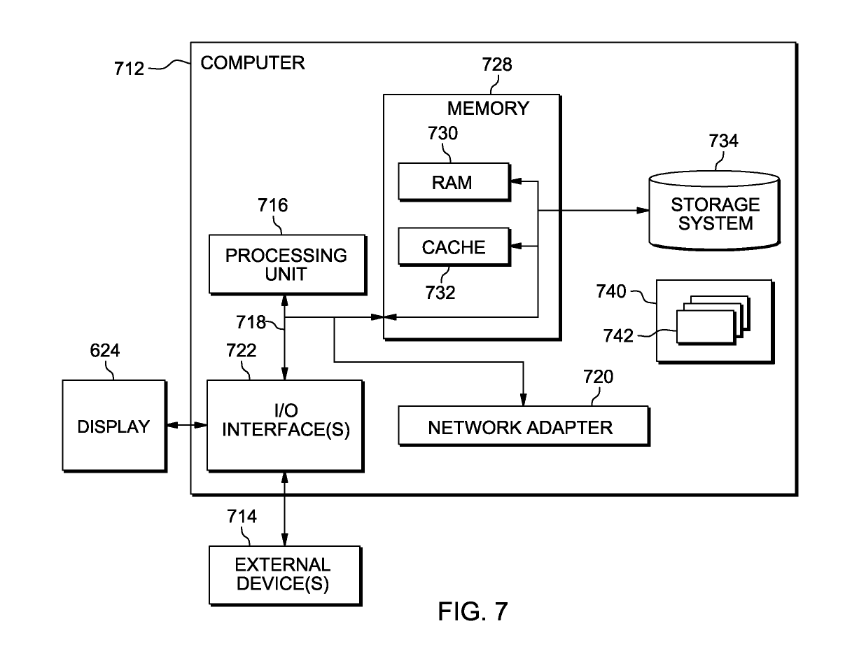

FIG. 7 is a functional block diagram of a computer system, in accordance with an embodiment of the present invention is shown.

Computer system 700 is only one example of a suitable computer system and is not intended to suggest any limitation as to the scope of use or functionality of embodiments of the invention described herein. Regardless, computer system 700 is capable of being implemented and/or performing any of the functionality set forth hereinabove. In computer system 700 there is computer 712, which is operational with numerous other general purpose or special purpose computing system environments or configurations. Examples of well-known computing systems, environments, and/or configurations that can be suitable for use with computer 712 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of requestor device 110, responder devices 120, 125, can include or can be implemented as an instance of computer 712.

Computer 712 can be described in the general context of computer system executable instructions, such as program modules, being executed by a computer system. Generally, program modules can include routines, programs, objects, components, logic, data structures, and so on that perform particular tasks or implement particular abstract data types. Computer 712 can be practiced in distributed cloud computing environments where tasks are performed by remote processing devices that are linked through a communications network. In a distributed cloud computing environment, program modules can be located in both local and remote computer system storage media including memory storage devices.

As further shown in FIG. 7, computer 712 is shown in the form of a general-purpose computing device. The components of computer 712 can include, but are not limited to, one or more processors or processing units 716, memory 728, and bus 718 that couples various system components including memory 728 to processing unit 716.

Bus 718 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 712 typically includes a variety of computer system readable media. Such media can be any available media that is accessible by computer 712, and includes both volatile and non-volatile media, and removable and non-removable media.

Memory 728 can include computer system readable media in the form of volatile memory, such as random access memory (RAM) 730 and/or cache 732. Computer 712 can further include other removable/non-removable, volatile/non-volatile computer system storage media. By way of example only, storage system 734 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 718 by one or more data media interfaces. As will be further depicted and described below, memory 728 can include at least one program product having a set (e.g., at least one) of program modules that are configured to carry out the functions of embodiments of the invention.

Requestor client program 111, responder client program 126 and server program 105, having one or more program modules can be stored in memory 728 by way of example, and not limitation, as well as an operating system, one or more application programs, other program modules, and program data. Each of the operating system, one or more application programs, other program modules, and program data or some combination thereof, can include an implementation of a networking environment. Requestor client program 111, responder client program 126 and server program 105 generally carry out the functions and/or methodologies of embodiments of the invention as described herein. Each one of requestor client program 111, responder client program 126 and server program 105 can be implemented as or can be an instance of program 740. Program 740, having one or more program modules 742, can be stored in memory 728 by way of example, and not limitation, as well as an operating system, one or more application programs, other program modules, and program data.

Computer 712 can also communicate with one or more external devices 714 such as a keyboard, a pointing device, etc., as well as display 724 one or more devices that enable a user to interact with computer 712; and/or any devices (e.g., network card, modem, etc.) that enable computer 712 to communicate with one or more other computing devices. Such communication can occur via Input/Output (I/O) interfaces 722. Still yet, computer 712 can communicate with one or more networks such as a local area network (LAN), a general wide area network (WAN), and/or a public network (e.g., the Internet) via network adapter 720. As depicted, network adapter 720 communicates with the other components of computer 712 via bus 718. It should be understood that although not shown, other hardware and/or software components can be used in conjunction with computer 712. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer-readable medium(s) having computer-readable program code embodied thereon.

In addition, any combination of one or more computer-readable medium(s) can be utilized. The computer-readable medium can be a computer-readable signal medium or a computer-readable storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium can be any tangible medium that can contain, or store a program for use by or in connection with an instruction execution system, apparatus, or device.

A computer-readable signal medium can include a propagated data signal with computer-readable program code embodied therein, for example, in baseband or as part of a carrier wave. Such a propagated signal can take any of a variety of forms, including, but not limited to, electro-magnetic, optical, or any suitable combination thereof. A computer-readable signal medium can be any computer-readable medium that is not a computer-readable storage medium and that can communicate, propagate, or transport a program for use by or in connection with an instruction execution system, apparatus, or device.

Program code embodied on a computer-readable medium can be transmitted using any appropriate medium, including but not limited to wireless, wireline, optical fiber cable, RF, etc., or any suitable combination of the foregoing. Computer program code for carrying out operations for aspects of the present invention can be written in any combination of one or more programming languages, including an object oriented programming language such as Java, Smalltalk, C++ or the like, conventional procedural programming languages such as the “C” programming language, a hardware description language such as Verilog, or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer program product for collaboratively sharing portions of a web document has been described. However, numerous modifications and substitutions can be made without deviating from the scope of the present invention. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the Figures. Therefore, the present invention has been disclosed by way of example and not limitation.

What is claimed is:

1. A method of collaboratively sharing portions of a web document within a computer system, the method comprising the steps of:
receiving a request from a requestor to redact web documents via a first collaboration tool of one or more collaboration tools;
identifying designated portions of information in the web documents;
redacting the designated portions of information of the web document;
transmitting the redacted designated portions of information of the web documents to a responder via a second collaboration tool of the one or more collaboration tools;
receiving from the responder an altered version of the redacted designated portions of information of the web documents via the second collaboration tool of the one or more collaboration tools;
redacting the altered version of the redacted designated portions of information of the web document; and
transmitting the redacted altered version of the designated portions of information of the web document to the requestor via the first collaboration tool of the one of more collaboration tools.

2. The method according to claim 1, wherein the step of transmitting the redacted altered version of the designated portions of information of the web document to the requestor further comprises:
replacing the designated portion of information of the web documents with the altered version of the web document.

3. The method according to claim 1, wherein the altered version of the designated portions of information of the web documents contains information entered by the responder in the second collaboration tool.

4. The method according to claim 3, designated portions of information of the web documents are populated with the information entered by the responder.

5. The method according to claim 1, wherein the designated portions of information of the web documents comprises private or confidential information entered in a text box of the one or more collaboration tools.

6. The method according to claim 1, wherein roles of redacting designated portions of information of web documents for either the requestors or the responder via the one or more collaborations tools is interchangeable.

7. The method according to claim 1, wherein the step of redacting the designated portions of information of the web document further comprises:
replacing the designated portions of information based on a matching algorithm.

8. The method according to claim 1, wherein the step transmitting the redacted altered version of the web document to the requestor via the first collaboration tool further comprises:
displaying the redacted altered version of the web document on a user interface of a requestor device.

9. A computer system for collaboratively sharing portions of a web document, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to receive a request from a requestor to redact web documents via a first collaboration tool of one or more collaboration tools;
program instructions to identify designated portions of information of the web documents;
program instructions to redact the designated portions of information of the web documents;
program instructions to transmit the redacted designated portions of information of the web documents to a responder via a second collaboration tool of the one or more collaboration tools;
program instructions to receive from the responder an altered version of the designated portions of the redacted web document via the second collaboration tool of the one or more collaboration tools;
program instructions to redact the altered version of the designated portions of the redacted web document; and
program instructions to transmit the redacted altered version of the web document to the requestor via the first collaboration tool of the one of more collaboration tools.

10. The computer system according to claim 9, wherein program instructions to transmit the redacted altered version of the designated portions of the web documents to the requestor further comprises:
program instructions to replace the designated portion of the web documents with the altered version of the web document.

11. The computer system according to claim 9, wherein the altered version of the designated portions of information of the web documents contains information entered by the responder in the second collaboration tool.

12. The computer system according to claim 11, designated portions of information of the web documents are populated with the information entered by the responder.

13. The computer system according to claim 9, wherein the designated portions of information of the web document comprises private or confidential information entered in a text box of the one or more collaboration tools.

14. The computer system according to claim 9, wherein roles of redacting designated portions of information of web documents for either requestors or a responder via one or more collaborations tools is interchangeable.

15. A computer program product for collaboratively sharing portions of a web document, the computer program product comprising:
one or more computer-readable tangible storage devices and program instructions stored on at least one of the one or more storage devices, the program instructions comprising:
program instructions to receive a request from a requestor to redact web documents via a first collaboration tool of one or more collaboration tools;
program instructions to identify designated portions of information of the web documents;
program instructions to redact the designated portions of information of the web documents;
program instructions to transmit the redacted designated portions of information of the web documents to a responder via a second collaboration tool of the one or more collaboration tools;
program instructions to receive from the responder an altered version of the redacted designated portions of the web document via the second collaboration tool of the one or more collaboration tools;
program instructions to redact the altered version of the redacted designated portions of information of the web document; and
program instructions to transmit the redacted altered version of designated portions of the web document to the requestor via the first collaboration tool of the one of more collaboration tools.

16. The computer program product according to claim 15, wherein program instructions to transmit the redacted altered version of the designated portions of information of the web documents to the requestor further comprises:
program instructions to replace the designated portion of the web documents with the altered version of the web document.

17. The computer program product according to claim 15, wherein the altered version of designated portions of information the web documents contain information entered by the responder in the second collaboration tool.

18. The computer program product according to claim 17, wherein designated portions of information of the web documents are populated with the information entered by the responder.

19. The computer program product according to claim 15, wherein the designated portions of information of the web documents comprises private or confidential information entered in a text box of the one or more collaboration tools.

20. The computer program product according to claim 15, wherein roles of redacting designated portions of information in web documents for either requestors or a responder via one or more collaborations tools is interchangeable.
